(19) United States
(12) Patent Application Publication
(10) Pub. No.: US 2012/0075139 A1
(43) Pub. Date: Mar. 29, 2012

(54) Method and Apparatus For Tracking or Tracing The Movement of Shipping Containers

(75) Inventors: Andre Gagnon, Gatineau (CA); Rene Schmidt, Clayton (CA); Daniel Robert Brooks, Ottawa (CA)

(73) Assignee: TEKTRAP SYSTEMS, INC., Gatineau (CA)

(21) Appl. No.: 13/238,724

(22) Filed: Sep. 21, 2011

Related U.S. Application Data
(60) Provisional application No. 61/387,608, filed on Sep. 29, 2010.

(51) Int. Cl. G01S 19/46; G01S 19/14

(52) U.S. Cl. 342/357.29; 342/357.52

(57) ABSTRACT

A covert device for tracing or tracking the movement of a shipping container has a primary satellite receiver responsive to external satellite signals to obtain positional information, a secondary receiver for obtaining coarse positional information from terrestrial radio signals, and a memory. A processor processes the available positional information to obtain a fix in response to an event and stores the fix in association with the event in memory. The receivers preferably use the shipping container at least in part as an antenna. When the secondary receiver is an FM broadcast antenna, the gap between the doors of the shipping container can serve as a slotted antenna.

### CROSS REFERENCE TO RELATED APPLICATION

This application claims the benefit under 35 USC 119(e) of U.S. Provisional Application No. 61/387,608, filed Sep. 29, 2010, the contents of which are herein incorporated by reference.

### FIELD OF THE INVENTION

This invention relates to generally to the field of transportation, and more particularly to a method and apparatus for tracking or tracing the movement of shipping containers.

### BACKGROUND OF THE INVENTION

The ability to track the movement of shipping containers in real time or near real time, or alternatively obtain historical information relating to their movement (movement tracing), is of particular interest to security services. For example, if a container has deviated significantly from its expected route or taken longer than expected that may indicate the possibility of tampering. It is also desirable to know the location of the container when an event, such as an intrusion or droppage, occurs.

The widespread use of GPS (Global Positioning System) suggests GPS or similar satellite-based location systems as one possible solution.

In order for GPS to obtain a fix reliably, a good antenna with a clear view of the sky is required. Good signals from at least three satellites are required to obtain a fix assuming the receiver is on the surface of the earth.

GPS satellites broadcast two types of data, Almanac and Ephemeris. Almanac data consists of the coarse orbital parameters for all satellites. Each satellite broadcasts Almanac data for all the satellites. This Almanac data is not very precise and is considered valid for up to several months. Ephemeris data by comparison is very precise orbital and clock correction for each particular satellite and is necessary for precise positioning. Each satellite broadcasts only its own Ephemeris data. The validity of this data is dictated by the particular satellite and may be valid up to 4 to 6 hours. The Ephemeris data is broadcast by each satellite every 30 seconds.

GPS receivers have a cold start mode and a warm start mode. Typically, a cold and warm start is defined as follows:
Cold Start—Time and position known to within some limits, almanac known, ephemeris unknown

Warm start—Time and position known to within some limits, almanac known, at least three satellite Ephemeris data are known from previous operation.

Unlike, navigational systems, where a continuous read-out of position may be required, tracking systems need only take fixes at defined intervals because there is a limit on the distance a shipping container can travel from an intended route within a specific time-frame. Typically a GPS receiver requires a cold start after being switched off for a certain amount of time. In a tracking system, battery-provided power is at a premium, and in order to conserve power, the GPS receiver needs to be switched off between fixes. This means that each time a fix is taken at periodic intervals, the GPS receiver needs to make a cold start.

A GPS receiver takes estimates position by taking all the information available at the time. The smaller amount of information, the worse is the quality of the fix. A GPS receiver located inside a shipping container for discretion does not have access to a good quality antenna or a clear view of the sky. A shipping container acts as a Faraday cage, so the electric field strength is essential zero inside. An external antenna would be subject to breakage and defeat the covert nature of the device. Also, shipping containers are typically stacked one upon the other, so even if an antenna were mounted externally, it would likely have a poor view of the sky.

GPS has thus not been considered suitable for tracking shipping containers. As an alternative, it is known to use FM broadcast signals to obtain an approximate fix. The location of each FM broadcast transmitter is known, and it is possible to create a database of FM spectra for a geographic area, such as North America. By matching the received spectrum with the database of spectra, it is possible to obtain an approximate position fix, typically within 5 to 10 kms. This, however, is nowhere close to the accuracy potentially available with a GPS receiver, which is in the order of a few meters or less. The FM technique is attractive because the gap between the doors of a typical container can act as a slotted antenna, and this antenna has the right dimensions, about 3 meters, suitable for picking up FM broadcasts. It is however too large to obtain a usable GPS signal, where the wavelength is in the order of 20 cms.

Some improvement to the GPS signal can be obtained by using a low noise amplifier, but this consumes relatively large amounts of power and is unsuitable for use in the tracking environment where power is at a premium.

### SUMMARY OF THE INVENTION

Embodiments of the invention provide a tracking or tracing method wherein an auxiliary source, such as an FM receiver, is used to obtain a coarse position from FM broadcasts, and the coarse position is then used to assist a GPS receiver. In this way, since the GPS receiver knows its approximate position, it is able to provide a more accurate position fix in the presence of poor GPS reception.

Alternatively, in the event that the GPS receiver is unable to provide a fix, the coarse position obtained by the FM receiver can be used to record the approximate position, typically to within 5 kms. In many situations, this may be sufficient. For example, insurance companies may want to know who had control of a container when it was dropped. The dropping can be detected by the accelerometer, and if, for example, a shipping company had control of the container within a certain area, an accuracy of 5 kms might be more than sufficient to identify the shipping company as responsible.

The satellite-based receiver is typically a GPS-based receiver, although it will be appreciated by one skilled in the art that the invention is equally applicable to other satellite-based systems, such as the Russian GLONASS.

Embodiments of the invention also provide an antenna design that provides coverage at FM, 2.43 GHz and 1.575 GHz frequencies that can be concealed within the rubber seal of a door slot of a shipping container. Advantage is taken of the fact that although a shipping container acts as a Faraday cage, and thus excludes electromagnetic fields, the gap between the doors acts as a slot antenna for FM frequencies, and the entire shipping container acts as one large composite antenna for Wi-Fi and GPS signals. The slot dimensions of a standard shipping container are best suited to FM frequencies, but the applicants have demonstrated that the antenna can also function at GPS and Wi-Fi frequencies. In the case of GPS frequencies, the reception is poor, but the poor reception can be overcome by using FM radiolocation to obtain an approximate position and thus provide a GPS assist.

According to one aspect of the invention there is provided a covert device for attachment to a shipping container to track or trace the movement thereof, comprising a primary satellite receiver responsive to external satellite signals to obtain positional information; a secondary receiver for obtaining coarse positional information from terrestrial radio signals; a memory; and a processor for processing the available positional information to obtain a fix in response to an event and store the fix in association with the event in memory, wherein the processor is configured to use the information from the secondary receiver to assist in obtaining an estimate of position from the signals from the satellite receiver.

If the satellite signals are unavailable, the processor may record a coarse fix in memory. This may be sufficient for some purposes, and is better than no fix at all.

The event could be a periodic wake-up signal or alternatively a trigger event resulting from an attempted intrusion into the container, or possibly the container being dropped.

The device is preferably dimensioned for concealment within the rubber door seal of the shipping container, and coupled to the container so that the container can serve at least in part as an antenna for the various signals.

In one embodiment of the invention, the first radiolocation receiver is coupled to the container via a dielectric type antenna, and the second radiolocation receiver is coupled via a patch antenna or inductive antenna. Although the shipping container itself, being made of metal, acts as a Faraday cage, the gap between the doors forms a antenna, which can pick up FM waves, and to a lesser extent satellite signals in the 1.5 GHz band.

In a further aspect, a third antenna, also coupled to the doors via a dielectric antenna, is provided in the gap to provide Wi-Fi communication with a remote access point in the 2.4 GHz band. Alternatively, an antenna may be provided for radio communication over the cellular network.

In another aspect the invention provides a method of monitoring the security of shipping containers, wherein a covert device is placed on a shipping on a shipping container, the covert device comprising a primary satellite receiver responsive to external satellite signals to obtain positional information; a secondary receiver for obtaining coarse positional information from terrestrial radio signals; a memory; and a processor for processing the available positional information to obtain a fix in response to an event and store the fix in association with the event in memory, wherein the processor is configured to use the information from the secondary receiver to assist in obtaining an estimate of position from the signals from the satellite receiver; the method comprising receiving data from the memory via a communications link; and providing access to the data over the Internet to permit clients to ascertain the security status of their shipping containers.

The monitoring can take place in real time, near real-time or on demand if the communications link is a satellite link with the data being transmitted by a transmitter that uses the slotted antenna formed by the gap between the doors of the container as its antenna.

In yet another aspect the invention provides a security system for a shipping container, comprising a covert device for attachment to the shipping container to track or trace the movement thereof, comprising a primary satellite receiver responsive to external satellite signals to obtain positional information; a secondary receiver for obtaining coarse positional information from terrestrial radio signals; a memory; and a processor for processing the available positional information to obtain a fix in response to an event and store the fix in association with the event in memory, wherein the processor is configured to use the information from the secondary receiver to assist in obtaining an estimate of position from the signals from the satellite receiver, wherein the covert device is dimensioned for concealment within the door seal of the shipping container; at least one detector for installation within the container responsive to an integrity breach and configured for wireless communication with the covert device; and a transmitter for sending data to a remote user over a communications link.

Another feature of the invention is that the data can be communicated to a user over a real-time satellite link using the slotted antenna formed by the door gap.

### BRIEF DESCRIPTION OF THE DRAWINGS

The invention will now be described in more detail, by way of example only, with reference to the accompanying drawings, in which:

FIG. 1 is a block diagram of a part of a tracking system in accordance with an embodiment of the invention;

FIG. 2 is an illustration of a system showing the main functional units of the tracking system for monitoring the interior of a container;

FIG. 3 shows the positioning of the door tag in a door seal;

FIG. 4 shows the placement of a test antenna between container doors; and

FIG. 5 shows the optimal location of transceivers.

### DETAILED DESCRIPTION OF EMBODIMENTS OF THE INVENTION

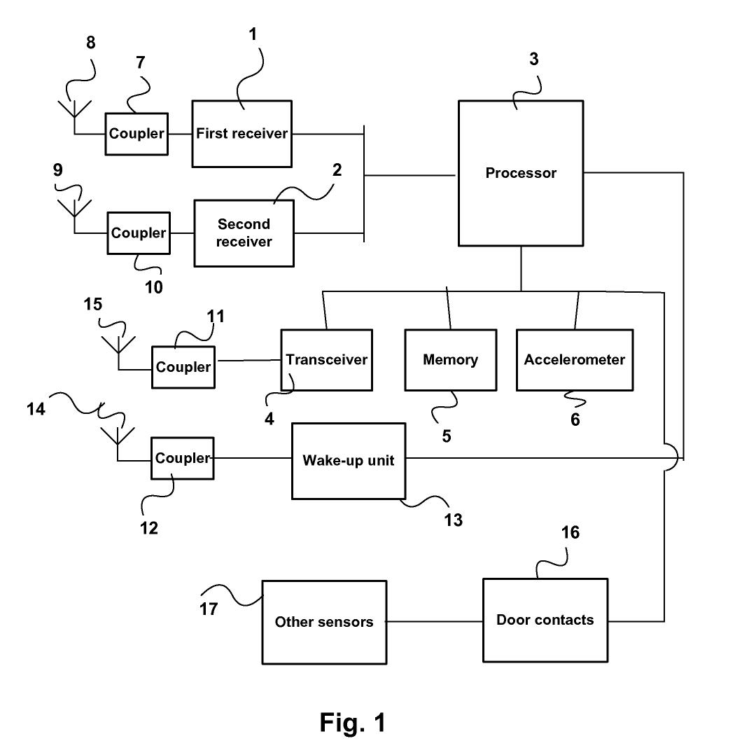

The tracking device shown in FIG. 1, which is known as a door tag because it is designed to be fitted in the door seal of a standard shipping container, comprises first radiolocation receivers 1, 2, a processor 3, transceiver 4, a memory 5, an accelerometer 6, and a wake-up unit 13. The door tag also includes an internal power source in the form of a battery (not shown). The processor is also connect to door contacts 16, which enable the device to determine the open/close status of the doors as well potentially as other sensors 17. These, for example, could be X-ray sensors.

The first receiver 1 is typically a global navigation satellite-based receiver (GNSS), such as a GPS receiver, although it could be another system, such as the Russian GLONASS system or the European Galileo system. This is coupled to antenna 8 through coupler 7. Antenna 8 can be a separate antenna mounted within the door seal of the shipping container, or can also be formed at least in part by the container itself.

The second receiver 2 is typically a receiver capable of picking up FM broadcast signals to enable a coarse position to be determined based on the FM spectrum. This receiver is coupled through coupler 10 to antenna 9, which may conveniently be the slotted antenna formed by the gap between the container doors.

The processor 3 computes positional information from the GPS signals, assisted by the coarse information from the second receiver 2.

The transceiver 4 is coupled through coupler 11 to antenna 15, which may also be formed in part by the container itself. The transceiver 4 may be used to exchange data with an external reader 23, for example over a Wi-Fi link, as the container passes particular point on a router. For example, in the case of a railway track, readers may be passed at strategic points along the route.

Alternatively, the transceiver 4 may be a satellite transceiver or transmitter designed to communicate via satellite with a remote user or base station. One suitable satellite system is known as Orbcom. This uses the 136 to 150 MHz band for the transfer of data on the uplink. The transceiver 4 can be used to send data either on demand, periodically, or in response to an event, such as an intrusion or droppage, to a remote user via the satellite uplink. This permits real-time, or near real-time monitoring of the container. Two-way transmission also allows a user to interrogate a container to determine its position and/or status.

One reason why this is feasible is that the wavelength of the 150 MHZ band is approximately 2 meters, which fits well with the length of the door gap in a container acting as a slotted antenna. Using the door gap as a slotted antenna, it is thus possible to upload data via satellite to a remove user. The coupling technique for the satellite transceiver is the same as for the FM radiolocation receiver described below.

The accelerometer 6 detects rapid acceleration, such as when the container is dropped, and can generate a signal to wake-up the device to obtain a position fix. Typically, the tag will be maintained in a sleep mode until woken up in order to conserve power. The fix may be recorded in the memory 5 along with the time. This information can be used by insurance companies to determine where a container was at the time it was dropped, and therefore who had responsibility for it.

The wake-up unit 13 also serves to wake up the system periodically to take and record a position fix. The processor is normally configured to go into sleep mode between fixes in order to conserver power. Alternatively, the system can be activated by a remote signal received through the antenna 14. This can also be a patch antenna.

A typical GPS receiver suitable for use as the first receiver has a sensitivity of −125 to −160 dBm and requires a minimum −142 dBm of received power in order to acquire (cold start) and lock a new satellite for the first time. Thereafter, the receiver requires a minimum received power of −159 dBm to remain locked (warm start) to continue tracking an existing satellite under typical reception conditions.

A suitable GPS receiver module for use in the tracking device is the MN5010HS GPS module by Micro Modulator Technologies. This requires a minimum Of −142 dBm of received power in order to cold start. Thereafter, it requires −159 dBm to remain locked (warm start).

Tests were performed with an inverted F antenna and a passive ceramic patch antenna. It was found that both antennas were able to cold start and track 5-8 satellites while mounted in the middle and inside the rubber gasket seal of a partially open container door, with a 180-degree horizon field of view. However, when they were placed in the middle and inside the rubber gasket seal between closed container doors with a 180-degree horizon field of view, neither antenna was able to cold start, but both were able to track 4-6 satellites (warm start). Thus, by using the FM radiolocation receiver as a GPS assist device, the antennas can be used to obtain a fix when the doors are in the closed position because with the FM radiolocation device providing the approximate position, the GPS receiver is able to warm start and maintain a fix based on the received satellite signals.

The results were the same indoors except only 4-5 satellites were tracked.

These tests demonstrate that the receiver has two distinct figures of merit: warm tracking −159 dBm; cold start −142 dBm. These numbers indicated a tracking margin of 17 dBm.

It was also found that the 3D radiation patterns (directivity gain) of a container-mounted covert antenna shows a bore sight null (blind spot) along with significant upper and lower main lobes to capture the LOS and ground reflected signals. The radiating device performance and effective isotropic radiation pattern in both the elevation and azimuth plane are influenced by the container door geometry; as is the wavelength at bore sight. The door gasket and mounting bracket creates about 10 dB of coupling loss that can be recovered with an active patch antenna to add gain.

Two commercial devices that solve this issue are Taoglas 10A or 12-A active patch antennas that provide gain (12-25 dB) in a low power (5-15 mA) miniature footprint suitable for the FM-TAG application.

The complex inter-gap geometry space between the container doors of the indoor test unit was rigorously measured and a numerical model created and sized large enough to contain the reactive near field with an outside dimension of (15.5×6×19) cm using the model shown in FIG. 4. The GPS IFA antenna was located between the two metal doors 41, 42, inside the gasket material 43 and parallel to and offset by 1 mm from the metal retainer plate. The geometry was defined using a fixed mesh cell size of xyz [0.5,0.5,0.5] mm and dielectric materials as necessary to capture a resemblance of an actual slice of the container doors such that the analysis represents what one could expect from the actual results.

Analysis and observations demonstrate that it is possible to achieve a level of success toward operating the GPS receiver within a container door gasket. The GPS receiver module can operate within the dynamic range margin with two types of passive antenna, a linear polarized IFA and a RHCP ceramic patch. With either antenna located in free space the received signal strength is above −142 dBm and with adequate S/N ratio within the cold-start operation threshold. Conversely, with either antenna located inside the closed doors of the container, there is not sufficient signal for warm-start tracking, which indicates inadequate S/N ratio. The analysis of the GPS module's SNR Vs NF indicates that we are very close to the S/N and cold-start threshold when inside the container door slot. The door gasket and mounting bracket creates about 10 dB of coupling loss and a 3 dB PLF that can be recovered with an active patch antenna to add gain.

For GPS, the ceramic patch antenna normally has good right hand circular polarization characteristics (RHCP) with good axial symmetry to match the polarization of the received GPS signals. Ceramic patches are the most commonly used style of antenna, with different shapes, sizes and styles of antennas available. Regardless of the construction, they will generally be either passive or active types.

In one embodiment the GPS antenna is coupled to the door via a dielectric load patch antenna. The entire container thus serves as an antenna for GPS signals.

As noted the gap between the doors of a shipping container serves as a slotted antenna in the FM broadcast range and can be used as the antenna for the second receiver 2. A GPS antenna incorporating the slotted antenna formed by the door gap does not function so well because the dimensions are not such that it is tuned to GPS frequencies. However, the inventors have found that it is still possible to obtain usable signals, albeit of relatively poor quality, by coupling the GPS receiver to the container itself. In this case, the entire container acts as a composite antenna.

While it would be possible to boost these signals with a low noise amplifier, such an amplifier consumes a significant amount of power and is thus not suitable for operation in a container environment, where a battery supplies the only power. A GPS works by making a continuous estimate of the position based on the information available. The poorer the quality of the input information, the worse the estimate, until there comes a point where the GPS receiver is not capable of providing a reasonable estimate. This situation is aggravated in a cold start situation where the GPS receiver has been powered down for some time, for example, several minutes. However, if a GPS receiver has an approximate position from another source, it is able to provide a reasonable estimate of position with much poorer quality signals than would otherwise be the case. This is known as assisted GPS. In accordance with an embodiment of the invention, the approximate positional information obtained from the first receiver is used to provide a coarse position, which then enables the GPS receiver to compute an estimate based on the poor quality signals from and the approximate position obtained from the first receiver.

In this way, it is possible to conceal a GPS within a shipping container and still obtain good fixes, within a few meters despite the fact that the GPS antenna does not have a clear view of the sky.

The second radiolocation receiver in this example is an FM broadcast receiver designed to pick up commercial radio broadcasts, such as FM radio broadcasts. Alternatively, it can be designed to pick up TV broadcasts or cellular frequencies.

Since the position of FM broadcast stations or cell towers is known, it possible to compute an approximate position from the received spectrum. One possibility is to store a database of spectra for different locations in a particular geographic area, such as North America, in memory 5, and compare in the processor 3, the received spectrum with the stored spectra. In this way it is possible to obtain approximate positional information.

A better solution is to make use of the location information contained in modern digital broadcasts. Digital broadcast stations include GIS information giving the precise location of the broadcast antenna. Knowing the location and signal strength enables an approximate distance to the station to be calculated. If more than one station is available an approximate position can be computed by triangulation.

As noted, it has been discovered that the gap between the doors of a shipping container provides a good slotted antenna. It turns out that the gap has just the right dimensions to be tuned for FM or TV broadcast frequencies. Thus, the second receiver 2 can be coupled through coupler 10 to antenna 9, which is in fact the slotted antenna formed by the gap between the doors. The coupler can be a short strip antenna, which couples to the door slot, or direct contact across the door gap.

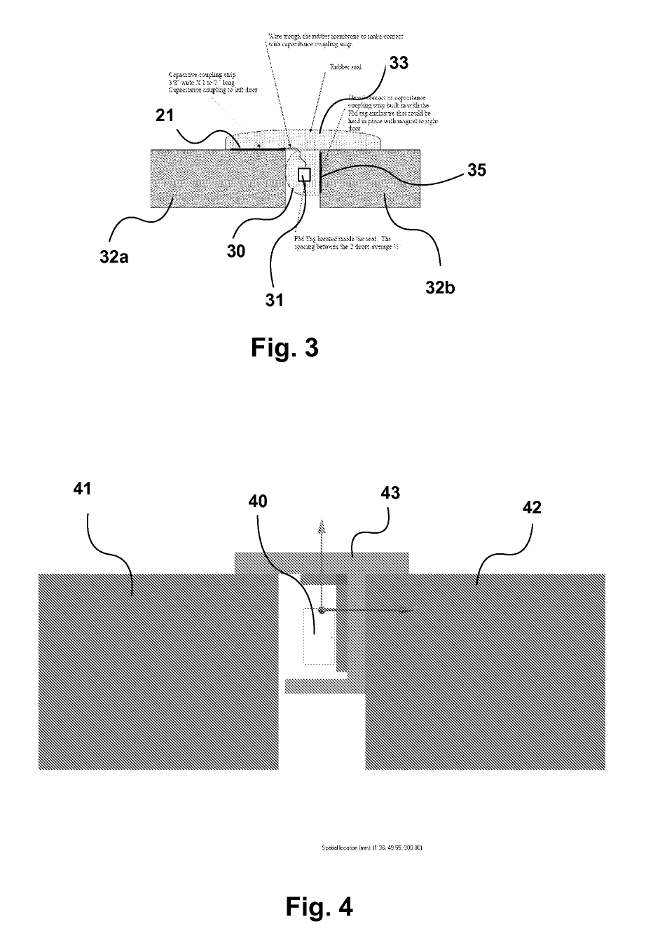

FIG. 3 shows the direct contact coupling to the doors 32a, 32b. The door tag 31, which is concealed inside the seal 30, is connected to capacitive coupling strip 21 mounted on the door 32a. In one example, the coupling strip is ⅜″ wide by 12″ long. The tag can also be coupled directly to coupling strip 35 mounted on the inside edge of the door. It might for example be held in place by magnetic attachment. It can also be inductively coupled to the door.

It will be appreciated that although FIG. 1 shows the processor as a single entity, part of the processing could be done in the first receiver and second receiver. For example, the approximate position obtained from the second receiver 2 could be fed into the first receiver 1, or alternatively the raw data from both receivers could be fed into processor 3, which computes the final position from both sets of data. Alternatively, the processing could be done in the GPS receiver, which would receive the approximate positional information as GPS assist information.

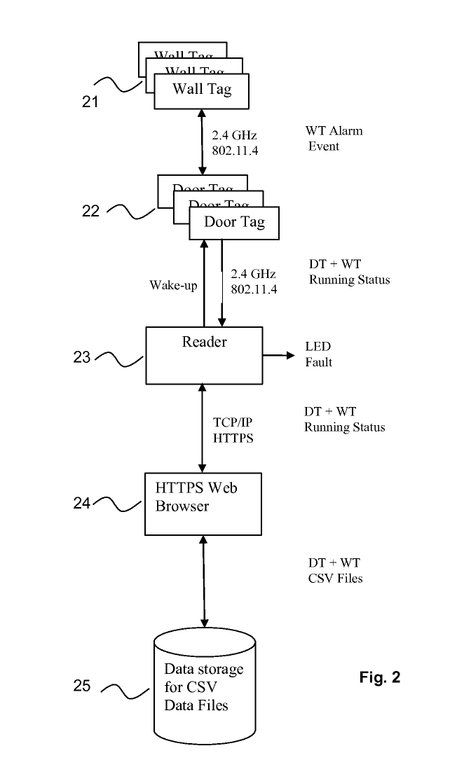

The processor 3 stores position and time information in memory 5, and also in one embodiment shown in FIG. 2 sends it through transceiver 4 to a reader 23, which in the case of a railway might be located at intervals beside the track, and from there to a remote monitoring station. The reader 23 may, for example, operate at Wi-Fi frequencies, in which case the container may transmit the data when it passes readers 23 placed at strategic locations. Position fixes are normally taken at predetermined intervals. However, if the accelerometer 6 has detected no movement, it is not necessary to take a fix, thus saving power.

One embodiment of a complete monitoring system shown in FIG. 2 comprises four components, known as tags, namely an optional wall tag (WT) 21 for monitoring the integrity and the interior and/or side panels of the container, a door tag (DT) 22 for identifying the location of the container, monitor the door status and to communicate the container status and data to the outside world. The door tag corresponds to the system shown in FIG. 1. The wall tag has a similar structure to the system shown in FIG. 1 without the first and second receivers. It detects breaches of wall integrity, for example, based on a change in electromagnetic characteristics, or capacitance, and transmits them to the door tag over an internal network, so that the door tag can store them and/or download them to an external reader along with positional information. The wall tag can conveniently by magnetic so that it can be directly applied on to the interior wall of a container.

The reader 23 may also be used to wake-up a nearby container, to interrogate the door tag and wall tag status, to transfer the data to a PC 25 via the Internet and a web browser 24. The PC 25 runs the Application Software to process the data. The processing of the data from both receivers to provide a position fix can be also be done in the reader 23.

A router (not shown) may be used to extend the range between the Reader and the PC.

The wall tag 21 is located inside the container, mounted on an inside wall or roof using a magnet and communicated with the reader 23 via the Door Tag 24. Being located inside the rubber seal of the door, the door tag 22 is capable of communicating inside the container with wall tag 21 and outside with reader 23. Responsible for low-duty-cycle monitoring of changes in the metal structure of the container to detect the time of a breach, the wall tag uses a low-power accelerometer-monitoring algorithm to detect vibration and shock. It can monitor changes in light, infrared and acoustics as well as changes in temperature and humidity, all grouped under others sensors 15. It stores condensed information such as a time-stamped at the time it differs sufficiently from a reference data sample otherwise at hourly intervals. The Wall-Tag can interface to 3rd party container monitoring equipment using hardwire or wireless. Optionally, it can wake up a Door-Tag with the provision of a large battery and modified antenna.

The door tag 22 is located inside the door seal of the container door. The door tag is responsible for monitoring significant changes in characteristic of door sensors 14 to detect changes in door status, and hence a breach in integrity. It uses the accelerometer 6 to detect motion and thereby decide when to monitor the GPS and FM signals at the appropriate duty cycle for both location and breach detection. It stores complete location, door sensors breach and accelerometer data plus wall-tag data when applicable.

The reader 23 is located within a 30 m distance of a container in transit or storage. It is responsible for waking-up a Door-Tag, receiving Door-Tag data, relaying messages and keeping RSSI and signal quality statistics for each tag. It is equipped with a GPS to identify the location of the Reader.

The reader's wireless range is a function of antenna gain and transmitter power. It is responsible for relaying messages sent by the Door-Tag via Internet/Intranet to the PC. The PC is then responsible to send the information/data via the Internet to the end-user. The PC is also responsible to run the application software and send messages via the Internet over a LAN when used in a closed-network Intranet) application. The Reader can retrieve RSSI and signal quality statistics for each Door Tag in the network.

In the example shown in FIG. 2, the wall tag communicates over Wi-Fi with the door tag to indicate integrity breaches. The door tag obtains a position fix and may store this information in memory 5. In addition, when the door tag comes within range of a reader 23, it is woken up and downloads the information to the reader 23.

This may in turn be retrieved over the Internet via web browser 24, and stored in data storage device 25. The system offers clients the ability to monitor the security of their containers in near real time by accessing the current data over the Internet. For example, a shipping company could periodically access the data for its containers in transit to check that no security breaches had occurred, or the security company could be automatically notified of breaches over the Internet along with data indicating the time and place of the breach.

The door tag packaging design is constrained by the need to be covert and be accommodated within the container door slot. Miniature antenna devices are required and are integrated so as to couple to the container doors, using the metal structure of the container as an antenna.

The door tag dimensions for the encasement of the PCB are driven by the available space provided by the container door geometry. The encased tag is inserted between the two metal doors inside the gasket material and parallel to and offset by 1 mm from the metal retainer plate.

In addition to the antenna for the GPS and FM receivers, the door tag also requires an antenna operative at 2.43 GHz for Wi-Fi communication with the external router. Various antenna designs including the Inverted-F antenna have been tried; however the Taoglas PA-15 proved to be ideal because of its miniature size. The antenna tuning profile is conducted with the antenna mounted inside the container doors. Factors such as layout, placement and packaging determine the PA-15 antenna's performance. In order for the module to perform correctly, the antenna-radiating element requires a clearance of approximately 3 mm from the surface of the enclosure to maintain the tuning profile.

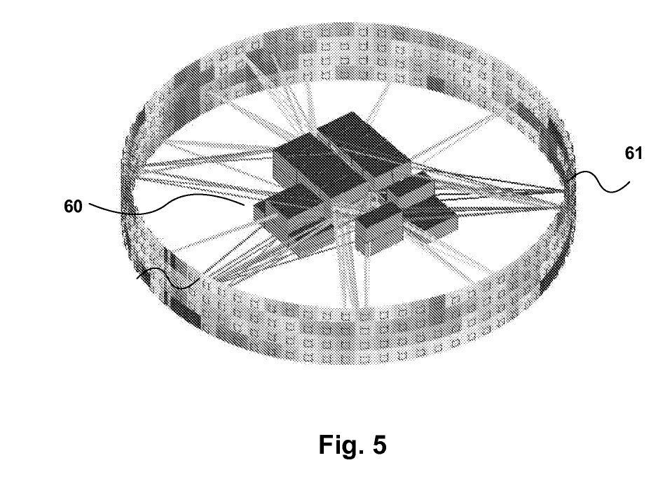

FIG. 5 shows a stack of containers 60. A transceiver with the actual 2.45 GHz radiation pattern is placed on the door of a container located at ground level midway within the stack. The effects of multipath on the signal transmission are viewed at the cylindrical receiver array 30 meters away as shown in FIG. 5. The preferred locations where wireless transceivers and network hub equipment such as Routers can be placed to maximize the range of the wireless network are shown indicated by 61.

Typically, the battery pack is held in place with a magnet and wired to the Door-Tag. The final Door-Tag will include a battery within the door rubber gasket.

Laboratory tests have shown that a 1 m×1 m cut-off section of the upper part of a maritime container does reproduce the same RF coupling effect as an entire maritime container. Therefore, to ease transportation logistics as well as testing the effect of orientation, cut-off sections of two maritime containers were mounted in 90° to each other and placed on a pick-up truck.

The longitudinal shape of the door tag allows the positioning of each one of the three antenna coupling mechanisms. The FM antenna couples to the door via a strip antenna or direct contact. The 2.43 GHz wireless and the GPS antenna couple to the door via the used dielectric load patch antenna.

Although, preliminary, the results are very encouraging showing an accurate path when GPS signals are captured, supported by a lower resolution path from FM signals.

In trials, a tag in accordance with an embodiment of the invention mounted in the door seal of a simulated shipping container maintained a GPS fix over 95% of the route despite being turned on and off in accordance with a chosen duty cycle. The remaining 5% of the route despite being coarse is produced by the FM Spectrum geo-locator algorithm. The road trial included dense urban, rural and mountainous areas.

Many North American, even more in Europe, FM broadcasters in the 88 to 108 MHz band have added digital FM to analog signals on their existing FM channels. In North America, terrestrial digital FM broadcasting uses the iBOC system design (in-band on-channel) developed by iBiquity Digital Corporation (http://www.ibiquity.com), marketed under the trade name “HD Radio.” Other schemes are used in Europe and elsewhere. It allows analog and digital transmissions to co-exist on a single channel.

Three data services are available, but the one of most interest is likely to be SIS (Station Information Service, which includes: Station ID Number (country code and FCC facility ID); Station Name; Local time, might or might not be GPS locked; Station Location (absolute 3-D geographic coordinates of the antenna feedpoint); Station Message—miscellaneous data, might or might not be useful; and SIS Message—miscellaneous system parameters.

One of the challenges of determining location using FM analog signals is that there may be multiple source transmitters for a particular frequency, especially when the transmitters are low-power. The addition of Station Location and Station ID will eliminate these ambiguities resulting in more accurate location calculations.

Embodiments of the invention are capable capable of determining the location of an event associated with a container to a minimum resolution of 10 m when still and 100 m in motion, capable of detecting door opening and closing status, capable of detecting side-panel and roof top intrusion, capable of sending its status within 30 m range of a reader, capable of being covert with no external or visible antenna, easy to install by non-technical staff, have a battery life of 6 months. It is projected that with volume production, the overall cost of a tag should be about $25.

1. A covert device for attachment to a shipping container to track or trace the movement thereof, comprising:
a primary satellite receiver responsive to external satellite signals to obtain positional information;
a secondary receiver for obtaining coarse positional information from terrestrial radio signals;
a memory; and
a processor for processing the available positional information to obtain a fix in response to an event and store the fix in association with the event in memory, wherein the processor is configured to use the information from the secondary receiver to assist in obtaining an estimate of position from the signals from the satellite receiver.

2. A covert device as claimed in claim 1, wherein the processor is configured to store a coarse position fix in memory based on the information from the secondary receiver when signals from the primary satellite receiver are unavailable.

3. A covert device as claimed in claim 1, which is dimensioned for concealment within the door seal of a shipping container.

4. A covert device as claimed in claim 1, wherein at least one of the receivers is coupled to the shipping container, which serves as an antenna.

5. A covert device as claimed in claim 4, wherein said at least one receiver is coupled to the shipping container by means of a dielectric patch antenna.

6. A covert device as claimed in claim 5, wherein the secondary receiver comprises an FM broadcast receiver configured to obtain an approximate position from received broadcast spectrum.

7. A covert device as claimed in claim 6, wherein the secondary receiver is coupled to a slotted antenna formed by a gap between doors of the shipping container.

8. A covert device as claimed in claim 7, wherein the secondary receiver is coupled to the doors by at least one inductive strip or direct contact.

9. A covert device as claimed in claim 6, further comprising a spectrum database, and wherein the FM broadcast receiver is configured to compare the received broadcast spectrum with the spectrum database to obtain said approximate positional information.

10. A covert device as claimed in claim 6, wherein the secondary receiver is configured to estimate the position based on the location of at least one transmitter determined from location data carried within the transmission.

11. A covert device as claimed in claim 10, wherein the secondary receiver is configured to compute the position based on the location of at least two transmitters.

12. A covert device as claimed in claim 10, wherein the transmitters are digital broadcast transmitters.

13. A covert device as claimed in claim 1, further comprising a transmitter for sending information stored in the memory to an external reader when the device is in the vicinity of the external reader.

14. A covert device as claimed in claim 13, wherein the transmitter is part of a transceiver establishing two-way contact with the reader.

15. A covert device as claimed in claim 14, wherein the transceiver is also configured to establish communication with detectors located within the shipping container.

16. A covert device as claimed in claim 15, wherein the detectors are wall tags capable of detecting breaches of wall integrity.

17. A covert device as claimed in claim 1, further comprising an accelerometer for detecting movement of the container, and wherein the processor is responsive to a signal from the accelerometer to initiate a position fix.

18. A covert device as claimed in claim 1, further comprising a wake-up module for waking up the processor to initiate a position fix at certain times or in response to an external signal.

19. A covert device as claimed in claim 1, which is responsive to signals from door sensors to store a fix in association with door open/close status.

20. A covert device as claimed in claim 1 in combination with a third receiver for receiving external electromagnetic signals, which is separate from said first and second radiolocation receivers and designed to be remotely located within the shipping container, said receiver being responsive to detect a change in electromagnetic field within the container due to an integrity breach, and said third receiver being in communication with said processor to record said integrity breaches in association with a position fix.

21. A covert device as claimed in claim 20, wherein said third receiver is adapted to communicate with said processor over a wireless network.

22. A covert device as claimed in of claim 1, further comprising a satellite transmitter, an antenna provided by a door gap between the doors of the container acting as a slotted antenna, and a coupler for coupling the transmitter to the antenna provided by the door gap, whereby the satellite transmitter can upload data via satellite to a remote user.

23. A covert device as claimed in claim 22, wherein the satellite transmitter is part of a transceiver providing two-way satellite communication.

24. A covert device as claimed in claim 22, wherein the coupler is an inductive strip.

25. A method of monitoring the security of shipping containers, wherein a covert device is placed on a shipping on a shipping container, the covert device comprising a primary satellite receiver responsive to external satellite signals to obtain positional information; a secondary receiver for obtaining coarse positional information from terrestrial radio signals;
a memory; and a processor for processing the available positional information to obtain a fix in response to an event and store the fix in association with the event in memory, wherein the processor is configured to use the information from the secondary receiver to assist in obtaining an estimate of position from the signals from the satellite receiver; the method comprising:
receiving data from the memory via a communications link; and
providing access to the data over the Internet to permit clients to ascertain the security status of their shipping containers.

26. A method as claimed in claim 25, wherein the data is received at an external reader over a wireless link as the shipping container passes the reader.

27. A method as claimed in claim 26, wherein the data is received over a satellite link from a transmitter in the covert device using a slotted antenna formed by a gap in the doors of the container as its antenna.

28. A method as claimed in claim 22, wherein the data is provided to clients by means of a web browser.

29. A security system for a shipping container, comprising:
a covert device for attachment to the shipping container to track or trace the movement thereof, comprising a primary satellite receiver responsive to external satellite signals to obtain positional information; a secondary receiver for obtaining coarse positional information from terrestrial radio signals; a memory; and a processor for processing the available positional information to obtain a fix in response to an event and store the fix in association with the event in memory, wherein the processor is configured to use the information from the secondary receiver to assist in obtaining an estimate of position from the signals from the satellite receiver, wherein the covert device is dimensioned for concealment within the door seal of the shipping container;
at least one detector for installation within the container responsive to an integrity breach and configured for wireless communication with the covert device; and
a transmitter for sending data to a remote user over a communications link.

30. A security system as claimed in claim 29, wherein the transmitter is configured to send the data to strategically located receivers as the shipping container moves in their vicinity.

31. A security system as claimed in claim 29, wherein the transmitter is configured to send the data to a remote user over a satellite link.

32. A security system as claimed in claim 31, wherein the transmitter is coupled to a slotted antenna formed by a gap between the doors of the container.

33. A security system as claimed in any one of claims 29 to 32, wherein the at least one detector is a wall tag mountable on a wall of the container for detecting a breach of integrity of the wall.

34. A security system as claimed in claim any one of claims 24 to 23, wherein the at least one detector is in Wi-Fi communication with the covert device.
